(19) United States
(12) Patent Application Publication
(10) Pub. No.: US 2006/0052154 A1
(43) Pub. Date: Mar. 9, 2006

(54) Electronic bingo game

(76) Inventor: Matthew J. Boerner, Bloomington, MN (US)

Correspondence Address: MERCHANT & GOULD PC, P.O. BOX 2903, MINNEAPOLIS, MN, 55402-0903, US

(21) Appl. No.: 10/934,750

(22) Filed: Sep. 3, 2004

(51) Int. Cl. G06F 17/00; G06F 19/00

(52) U.S. Cl. 463/19

(57) ABSTRACT

A method of using an electronic gaming system includes a user selectable marker for use in marking game cards displayed on a game terminal. The player may create and use a custom marker. The player may also change the display characteristics of the custom marker or any standard marker used to mark the game cards.

### TECHNICAL FIELD

The present application relates generally to improvements to electronic bingo games and more specifically to improvements to card markers used by players of electronic bingo games.

### BACKGROUND

Electronic bingo games typically involve a player seated at a video or other electronic display device showing one or more bingo cards currently in play. As the draw is made and the drawn letters and numbers are indicated, the player will scan the one or more cards to determine if the drawn number is in one of the columns shown and marks the cards electronically. To mark the cards, the player selects the number on a screen of the display device with a mouse pointer, a stylus, or some other pointing device, including a finger. The selected number is marked or “daubed,” on all of the player's cards and the player waits for the next number to be drawn.

When playing on screen, the mark or daub displayed in the selected number's position may take a variety of pre-selected shapes or forms. Examples of existing marks in use include many popular computer icons or images, such as stars, moons, smiley faces and a tremendous additional variety of shapes. While a large number of pre-set images or icons may be presented to the player to select from, improvements to existing electronic bingo games are desirable to allow a user to choose a custom daub and to change the display characteristics of the pre-set or custom daubs.

### SUMMARY

The present invention relates to a method of an electronic bingo game player selecting a custom marker. The method includes providing a networked video gaming system including at least one player video game terminal for displaying a game to the player. The player logs into the game terminal using a unique control number. The game terminal displays a menu of marker options for the user to choose from to mark a game card displayed on the game terminal during the game, the menu including at least one custom marker option provided by the player. The player selects the custom marker to use in marking the game card. The gaming system enters the player into the game and the player marks the game card displayed on the game terminal with the selected marker.

### BRIEF DESCRIPTION OF THE DRAWINGS

The accompanying drawings, which are incorporated in and constitute a part of the specification, illustrate several aspects of the present invention and together with the description, serve to explain the principles of the invention. A brief description of the drawings is as follows:

FIG. 1 is a schematic diagram of a networked electronic gaming system according to the present invention.

FIG. 2 is a screen shot of a log in screen for a player of the gaming system of FIG. 1.

FIG. 3 is a screen shot of a game marker selection menu according to the present invention.

FIG. 4 is a screen shot of a player terminal of the gaming system of FIG. 1, with a display including a plurality of game cards marked with a custom game marker.

FIG. 5 is the screen shot of FIG. 4, marked with a different game marker, some of the markers having altered display characteristics.

FIG. 6 is the screen shot of FIG. 5, with all the game markers including the same display characteristics.

FIG. 7 is a flow chart illustrating a process of creating a new player ID and a new custom marker for a player.

FIG. 8 is a flow chart illustrating a process of a player preparing to play an electronic game.

### DETAILED DESCRIPTION OF THE PREFERRED EMBODIMENT

Reference will now be made in detail to the exemplary aspects of the present invention that are illustrated in the accompanying drawings. Wherever possible, the same reference numbers will be used throughout the drawings to refer to the same or like parts.

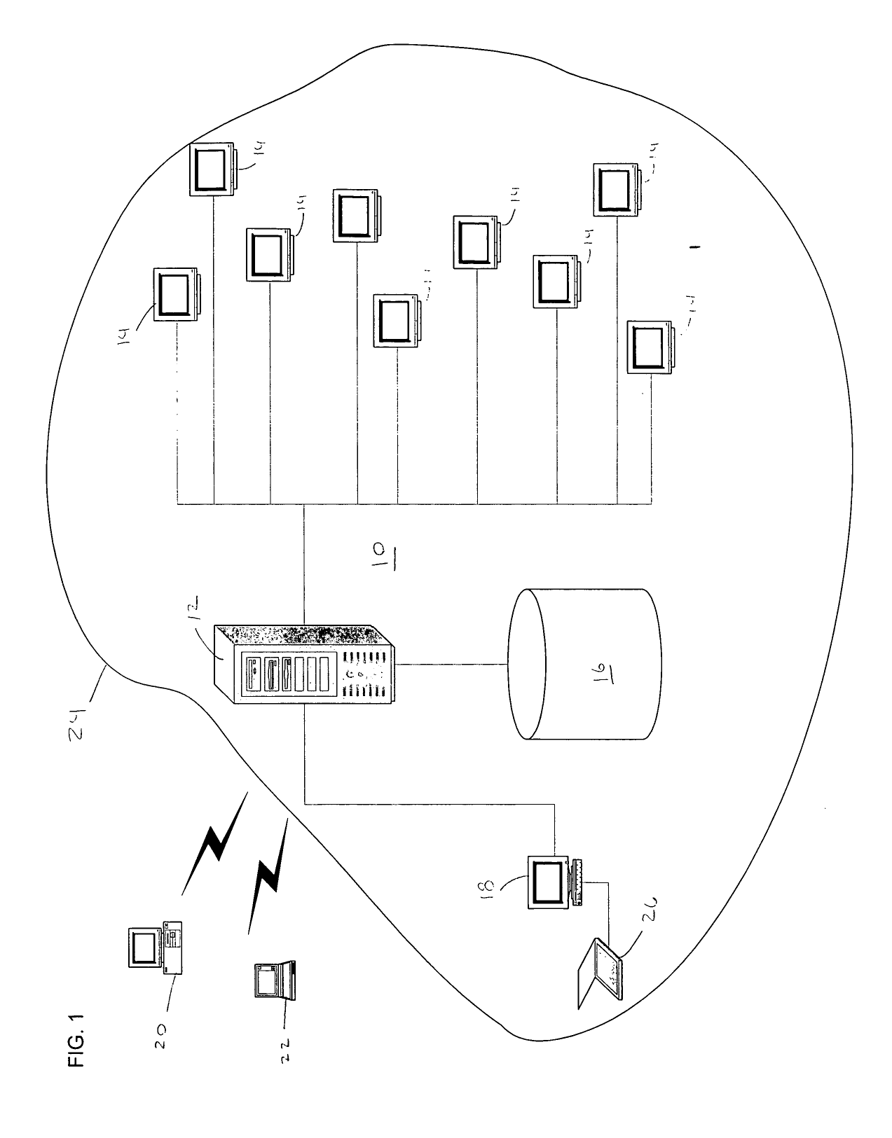

FIG. 1 shows a networked gaming system 10 including a server 12 and a plurality of player terminals or consoles 14. Gaming system 10 may also include a central database storage 16 where player information is stored, so that repeat players may log-in to retrieve previously input user information. Gaming system 10 may also include a player registration terminal 18, allowing players to enter information and select player and display preferences prior to logging into a player terminal 14. Alternatively, player registration may be through a remote access terminal, such as remote terminals 20 and 22. These remote terminals may be connected to the gaming system 10 via a telecommunications link, such as a wireless or cellular connection or via the internet, and permit players to remotely enter new information and make preference selections prior to entering a gaming establishment 24 at which gaming system 10 is located.

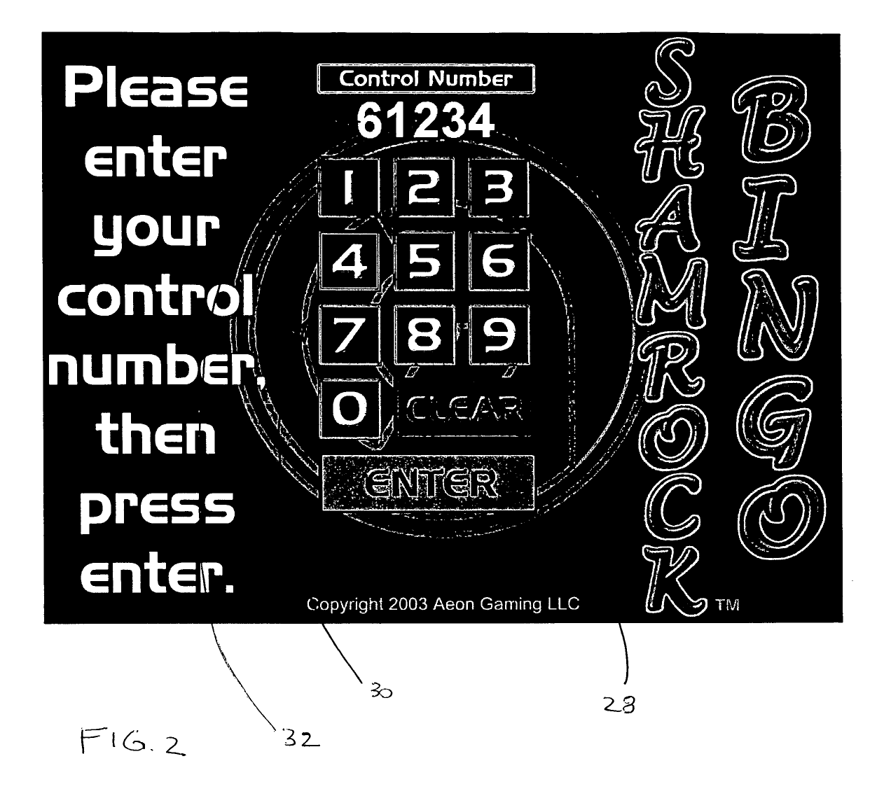

For a player to participate in play on gaming system 10, the player needs to have purchased, acquired or been given credit for cards or other game pieces. Once this purchase or acquisition has been accomplished, the player may log into gaming system 10 to play. Referring now to FIG. 2, a player log-in screen 28 which might be displayed on one of the game terminals 14, is shown. The player has already been registered and has purchased credit for the game, in this case, bingo. When the player purchases or receives credit for play, the player is given a control number which identifies the player and the number of games available to that player. The control number is entered into input box 32 using touch screen keypad 30.

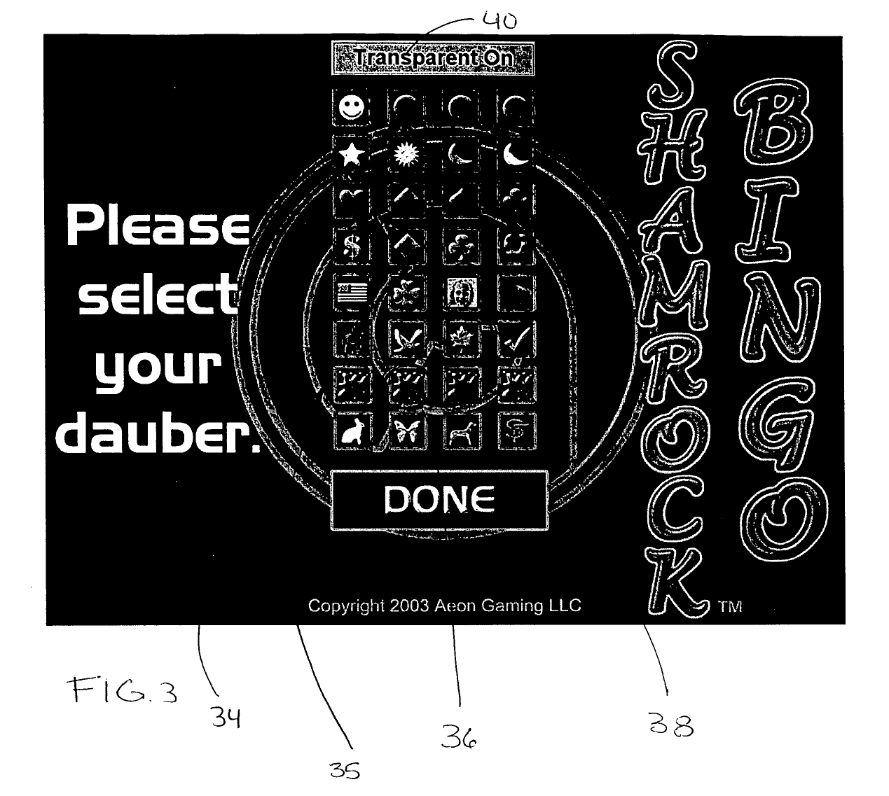

Once the control number has been entered and accepted, the player may then be directed to a marker selection screen 34, shown in FIG. 3. Screen 34 presents the player with a number of choices of icons in a menu 35 which the player may use to mark his or her bingo card. In bingo, these markers a commonly called daubs or daubers. While menu 35 includes a plurality of markers which are standard and may be presented or available to all players, menu 35 may also include one or more custom markers 38. Custom marker 38 will only be displayed for the player who has entered the marker and had it associated with his or her player preferences in database 16.

A player may enter custom marker 38 to be associated with his or her player preferences when creating a player registration or may add custom marker 38 at a later date by accessing and changes preferences. As the player preferences are associated with the players control number when logging into a game terminal 14, whatever the status of the player preferences are at the time of play will be displayed on terminal 14.

To input a custom marker, a player may follow one of several approaches, depending on the format or nature of the object used to derive the custom marker. As shown in FIG. 3, custom marker 38 is an image of a photograph supplied by the player. If the player arrives at gaming establishment 24 with a photograph, the player may log into player registration terminal 18 to which an image capture device such as a scanner 26 may be connected. The photograph would be inserted within scanner 26 which would capture a digital file of the photograph a standard digital format, such JPEG, GIF, TIFF, bitmap, etc. Preferably, the digital image will be in bitmap format, but other formats can be used depending on the gaming software driving gaming system 10 and how it is programmed and configured. This digital image is then associated with the player's preferences and will be inserted within menu 35 when the player logs into a game terminal 14 to play the game.

Also included in menu 35 is a display characteristic selection button 40. The function of this button is described in further detail below.

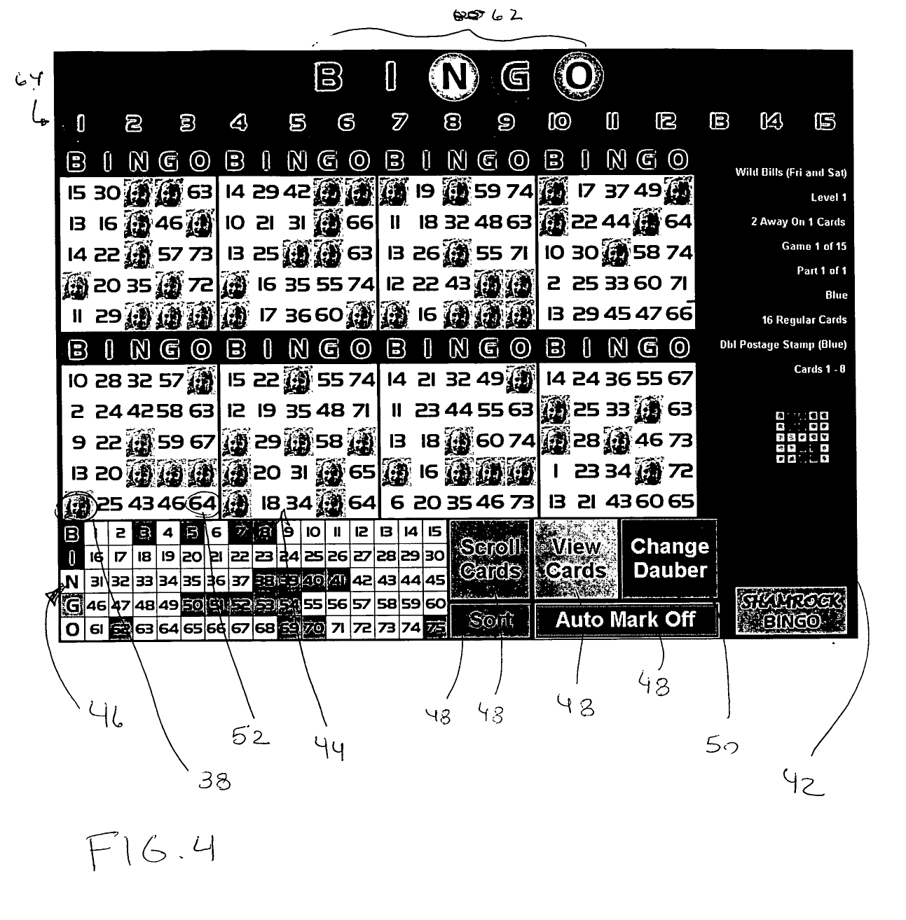

Once the player has selected a marker 36 or a custom marker 38 from menu 35, the player may proceed to game screen 42, shown in FIG. 4. FIG. 4 shows custom marker 38 used as a dauber to mark bingo cards 44 displayed on screen 42. Screen 42 may also include a plurality of game and card controls 48, which allow a player to alter the appearance or order of the game cards 44 displayed in screen 42, or turn game controls on or off, such as auto-marking of cards 44. Screen 42 also includes a game status board 46 where all drawn numbers for the game are displayed. Cards 44 are commonly known bingo cards, with randomly generated numbers in specific groupings positioned in five columns of five number each, with a central space as a free space. When a number is drawn and called out or displayed in status board 46, the player may mark cards 44 corresponding to the number drawn. To select a number listed on one of the cards 44, the player would select one of the five letters BINGO 62 across the top of screen 42. Depending on the letter 62 selected, a row of numbers 64 adjacent the letters will change to correspond to the letter. For example, if letter 62 B is selected, numbers 64 from 1 to 15 will be displayed. The player then selects the appropriate drawn number from numbers 64 and game terminal 14 marks all displayed cards 44 that include that number with the currently selected marker 38. Screen 42 also includes a button 50 which allows the player to return to marker selection screen 34 and menu 35 to select a new marker 36 or 38, or to change the display characteristics of the marker 36 or 38 currently being used.

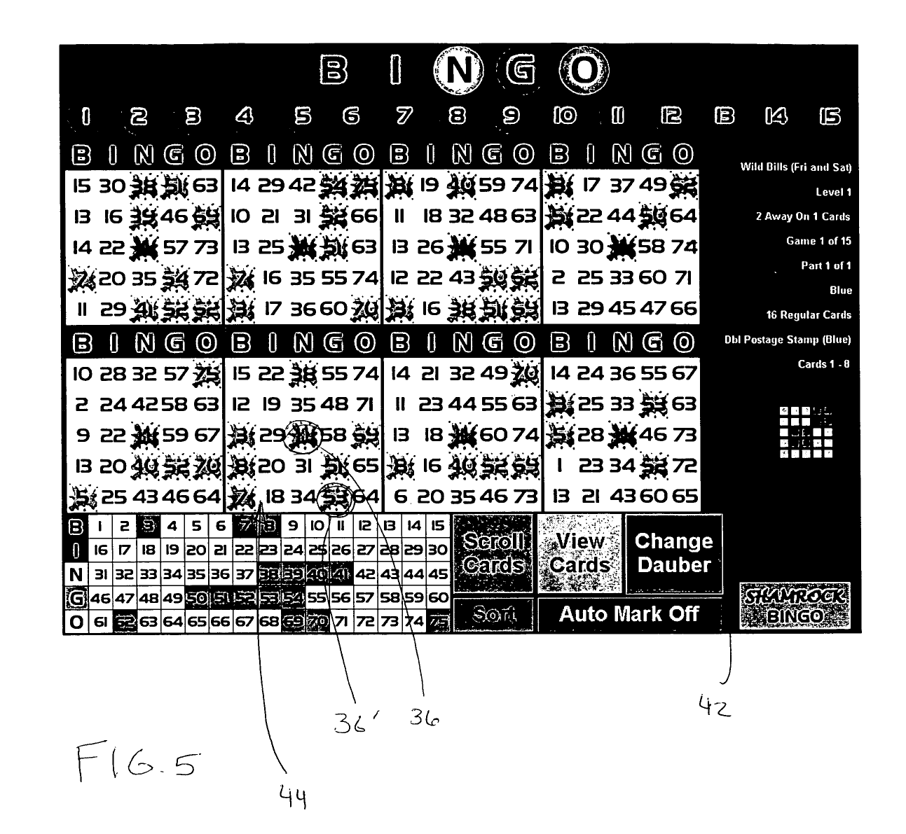

Screen 42 of FIG. 5 shows cards 44 which have been marked with a different marker 36. Some of the markers 36 used by the player to mark cards 44 are standard markers 36 which have had the display characteristic of transparency altered. These markers are labeled 36′, as compared to the markers 36 which have been used to mark the free space centrally located on each card 44. The player is responsible for marking only those numbers which have been drawn and called out during the game. The markers 38 used in FIG. 4 completely occlude visibility of the underlying numbers on card 44. If a player inadvertently marks a number not yet drawn and called out, the player will ineligible to win the game if that incorrectly marked number is part of the BINGO line. Altering the transparency of marker 36′ allows the player to verify that the underlying number matches one of those drawn and called out during the game to aid the player in avoiding incorrect marking. Altering the transparency or other display characteristics of markers 36 and 38 may be accomplished with any of a variety of commercially available software development and graphic editing packages. In the preferred embodiment shown in the FIGS., a GDI+ graphic routine from Microsoft Corporation was used, but it is anticipated that other tools or routines may be used within the scope of this invention.

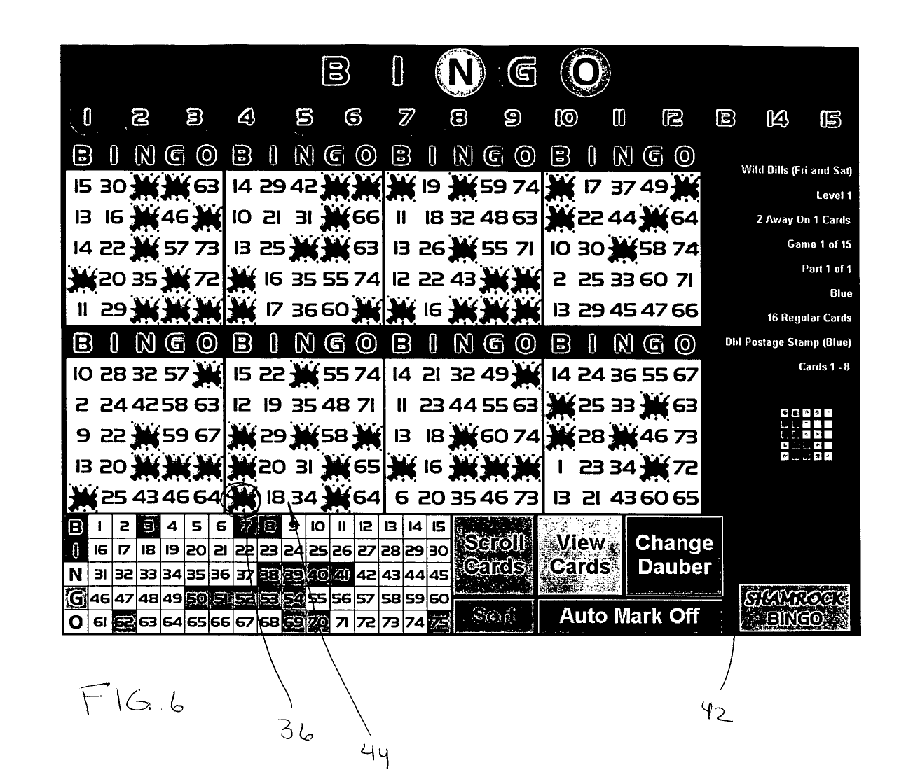

FIG. 6 shows game screen 42 with the same configuration as FIG. 5, but having all markers 36 used to mark numbers in cards 44. None of the markers 36 have transparency enabled, so that marker 36 completely occludes the underlying number. Custom marker 38 could similarly have its transparency adjusted. To adjust the transparency of markers 36 and 38, a player may access marker selection screen 34 and menu 36 when initially logging into system 10 or at any time while playing the game, using button 50. On menu 35 is button 40, which permits the player to alter the transparency of the chosen marker, either one of the standard markers 36 or custom marker 38. Once a marker 36 or 38 and the desired display characteristics have been selected, any marks made on game cards 44 in screen 42 will reflect those choices. Any marks previously made during play may or may not be altered to reflect the new marker or display selection, depending on the players preference. As a default, new selections of marker and/or display characteristics will not effect the previously made marks.

When the player is completed playing the game or games on game terminal 14, the player can log out of the terminal, ending a game session. The player's preferences for marker and display characteristics at the end of the game session are saved by gaming system 10 in database 16. When the player returns to a game terminal 14 of gaming system 10 for a future game session, gaming system 10 may default to the same selected marker and display characteristics from the end of the most recent prior game session.

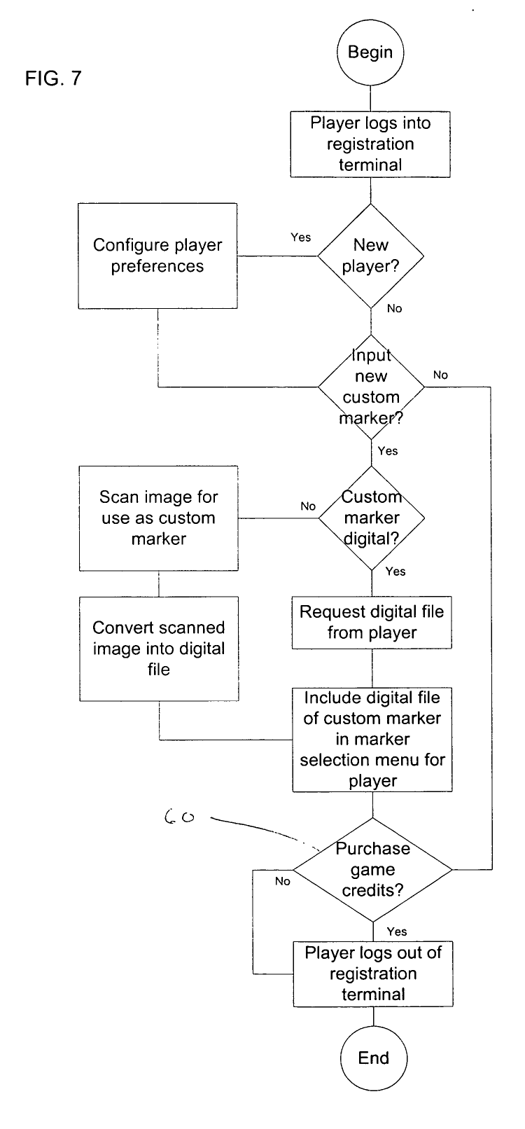

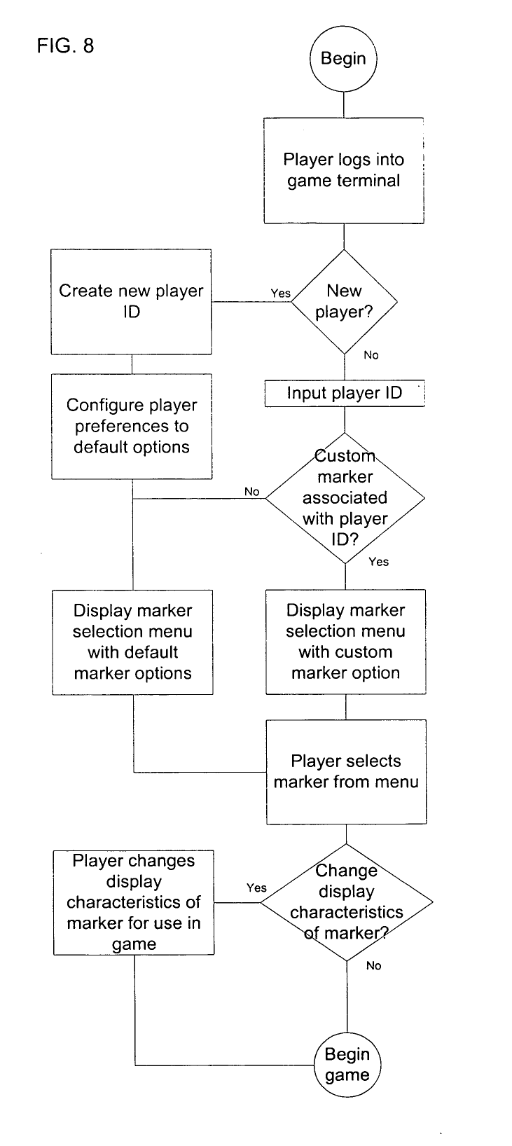

FIG. 7 illustrates a process by which a player may be registered within gaming system 10 and may also include a custom marker 38 into the menu 35 along with standard markers 36. In this process, a player may also purchase game credits at box to permit the player to log into a game terminal 14 and play the game. FIG. 8 illustrates a process for a player to initiate playing a game at terminal 14. If the player was a new or unregistered player who already had a control number, game terminal 14 may provide this player with a game setup including only standard markers 36 in menu 35, as custom markers 38 may only be added by using player registration terminal 18, or remote terminals 20 or 22. If the player has already configured a custom marker 38, when the player logs into game terminal 14 with a control number, the player with be shown menu 35 with the player's custom marker 38 included in the list of options. Regardless of whether the player is using a standard marker 36 or a custom marker 38, the display characteristics, such as transparency, may be controlled by the player at game terminal 14.

The above specification, examples and data provide a complete description of the manufacture and use of the invention. Since many embodiments of the invention can be made without departing from the spirit and scope of the invention, the invention resides in the claims hereinafter appended.

What is claimed is:

1. A method of an electronic bingo game player selecting a custom marker, the method including:
providing a networked video gaming system including at least one player video game terminal for displaying a game to the player;
the player logging into the game terminal using a unique control number;
the game terminal displaying a menu of marker options for the user to choose from to mark a game card displayed on the game terminal during the first game, the menu including at least one custom marker option provided by the player;
the player selecting the custom marker to use in marking the game card;
the game system entering the player into the game and the player marking the game card displayed on the game terminal with the selected custom marker.

2. The method of claim 1, further comprising the player presenting a image to the gaming system prior to logging into the game terminal, and the gaming system incorporating the player-supplied image into the menu of marker options available to the player when the player logs into the gaming terminal.

3. The method of claim 2, wherein the image presented by the player to the gaming system is a hardcopy image, and the method further comprises the gaming system scanning the hardcopy image into a digital form, and displaying a the digital form of the image in the marker option menu when the player logs into the game terminal.

4. The method of claim 2, wherein the image presented by the player to the gaming system is a digital image, and the method further comprising the gaming system displaying the digital image in the marker option menu when the player logs into the game terminal.

5. The method of claim 1, further comprising the player selecting display characteristics of the selected custom marker and the game terminal displaying the selected marker during play according to the selected display characteristics.

6. The method of claim 1, further comprising the player logging out of the first game on the game terminal and logging back into the game terminal for a second game at a later time, and the game terminal utilizing the selected custom marker from the first game for the second game.

7. The method of claim 5, further comprising the player logging out of the first game on the game terminal and logging back into the game terminal for a second game at a later time, and the game terminal utilizing the selected custom marker and display characteristics from the first game for the second game.

8. The method of claim 1, further comprising the player accessing the marker option menu during the first game and selecting a new marker for use during the first game, and the game terminal displaying the new marker during the first game.

9. The method of claim 1, further comprising the player accessing the marker option menu during the first game and selecting a new display characteristics for the selected custom marker for use during the first game, and the game terminal displaying the selected custom marker with the new display characteristics during the first game.

10. The method of claim 5, wherein the selected display characteristic includes the degree of transparency of the selected marker, allowing marking on a game card displayed to the player by the game terminal to be selectively visible through the selected custom marker.
